(19) United States
(12) Patent Application Publication
(10) Pub. No.: US 2025/0031235 A1
(43) Pub. Date: Jan. 23, 2025

(54) MEASUREMENT FOR A SUPER-UE

(71) Applicant: Apple Inc., Cupertino, CA (US)

(72) Inventors: Fangli XU, Beijing (CN); Alexander SIROTKIN, Herzliya (IL); Haijing HU, Los Gatos, CA (US); Naveen Kumar R. PALLE VENKATA, San Diego, CA (US); Pavan NUGGEHALLI, San Carlos, CA (US); Ralf ROSSBACH, Munich (DE); Sarma V. VANGALA, Campbell, CA (US); Sethuraman GURUMOORTHY, San Ramon, CA (US); Yuqin CHEN, Beijing (CN); Zhibin WU, Los Altos, CA (US)

(21) Appl. No.: 18/711,024

(22) PCT Filed: Nov. 19, 2021
(86) PCT No.: PCT/CN2021/131867

§ 371 Date: May 16, 2024

(51) Int. Cl. H04W 72/542; H04W 76/15; H04W 76/23

(52) U.S. Cl. CPC H04W 72/542; H04W 76/15; H04W 76/23

(57) ABSTRACT

One embodiment described herein takes the form of a user equipment (UE). The UE includes a transceiver and a processor. The processor is configured to associate with a secondary UE for collaborative transmission of a data payload of one of the UE or the secondary UE to a base station. The processor is configured to determine a link quality with the base station or the secondary UE, and determine a location of the UE or the secondary UE while associated with the secondary UE. The processor is configured to transmit to the base station or the secondary UE at least the determined link quality or the determined location, and determine to maintain, re-establish, or disable the association with the secondary UE based on at least one of a number of factors including: the determined link quality, the determined location, or an indication received from the base station.

### CROSS-REFERENCE TO RELATED APPLICATION

This application is a 35 U.S.C. § 371 application of PCT/CN2021/131867, filed on Nov. 19, 2021, and entitled “Measurement for a Super-UE,” which is incorporated herein by reference as if fully disclosed herein.

### TECHNICAL FIELD

Embodiments described herein generally relate to wireless communication systems, including methods and apparatus for obtaining and using measurements for a Super-UE.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE DRAWINGS

To easily identify the discussion of any particular element or act, the most significant digit or digits in a reference number refer to the figure number in which that element is first introduced.

FIG. 1 depicts an example radio access network of a number of cells.

FIG. 2 depicts a virtual cluster of wireless communication devices, according to embodiments disclosed herein.

FIG. 3 depicts an example super-UE radio resource control (RRC) connection, according to embodiments disclosed herein.

FIG. 4 depicts an example of an anchor UE based super-UE RRC connection, according to embodiments disclosed herein.

FIG. 5 depicts an example message flow for maintaining, re-establishing, and/or disabling a super-UE RRC connection based on a radio signal quality for a UE link, according to embodiments disclosed herein.

FIG. 6 depicts an example message flow for maintaining, re-establishing, and/or disabling a super-UE RRC connection based on a radio link status, according to embodiments disclosed herein.

FIG. 7 depicts an example message flow for maintaining, re-establishing, and/or disabling a super-UE RRC connection based on an inter-UE connection or link status, according to embodiments disclosed herein.

FIG. 8 depicts an example message flow for maintaining, re-establishing, and/or disabling a super-UE RRC connection based on the location of two or more UEs of a super-UE, according to embodiments disclosed herein.

FIG. 9 depicts an example architecture of a wireless communication system, according to embodiments disclosed herein.

FIG. 10 depicts a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with a network. Therefore, the UE as described herein is used to represent any appropriate electronic device.

Embodiments described herein describe a wireless connection device (user equipment (UE)) and message flow between one or more UEs with a base station (e.g., an eNodeB, an eNB, a gNB) to establish a super-UE radio resource control (RRC) connection. A UE, upon powering on, establishes a RRC connection with the base station to access network resources to communicate with a core network for various services and/or features. Using the RRC connection, the UE exchanges signaling information with the base station for establishing, modifying, and releasing of signaling radio bearer (SRB) path and data radio bearer (DRB) path. The RRC connection is also used for exchange of paging information, handover information, and measurement reporting.

As described herein, a UE at an edge of a cell coverage area may not transmit data (e.g., data payload) in an uplink direction (e.g., from the UE to the base station) at a higher transmission power to avoid interference with other neighboring UEs. Accordingly, available bandwidth for data transmission may be limited for data transmission between the UE and the base station. A UE can, however, collaborate with one or more other UEs for data transmission, and thereby the throughput of the data transmission can be improved. The UE in collaboration with the one or more other UEs for data transmission at higher throughput creates a virtual cluster of UEs. The virtual cluster of UEs, through UE aggregation, may be referenced as a super-UE in the present disclosure. As described in detail below, aggregation of two or more UEs may allow the two or more UEs to achieve higher data throughput. The higher data throughput, e.g., transmission of data in an uplink direction, from a UE to a base station, may be achieved without the UE needing to transmit data at an increased transmit power. Accordingly, the embodiments described in the present disclosure may improve user experience.

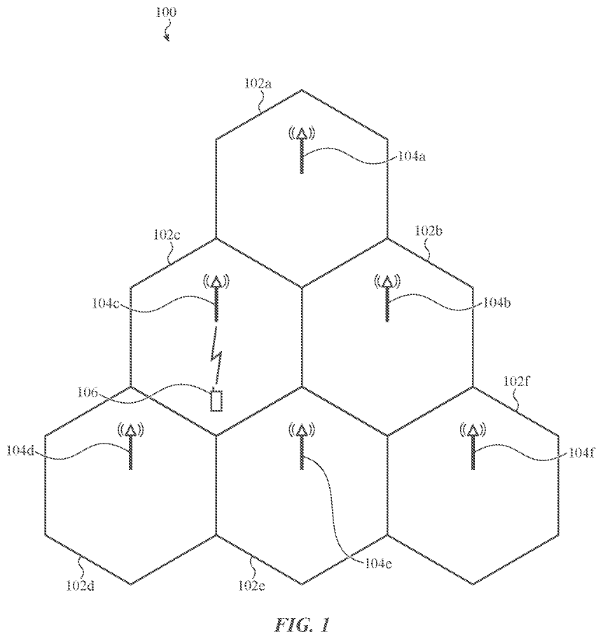

FIG. 1 depicts an example radio access network of a number of cells. A radio access network 100 may include a number of cells 102a, 102b, 102c, 102d, 102e, and 102f. Each cell of the number of cells may provide radio access coverage through a base station. For example, a base station 104a in the cell 102a may provide radio access to one or more UEs in a cell coverage area of the cell 102a. Similarly, base stations 104b, 104c, 104d, 104e, and 104f may provide radio access to one or more UEs in a cell coverage area of cells 102b, 102c, 102d, 102e, and 102f, respectively.

A UE 106 in the cell 102c, when more proximate to the base station 104c, may transmit data in the uplink direction at a higher throughput. The UE 106 may not require a higher transmit power for transmission of the data in the uplink direction due to a good quality radio signal strength. But as the UE 106 moves away from the base station 104c, near an edge of the cell 102c, a radio signal from the base station 104c may become weak due to fading and/or interference from radio signals from base stations in other neighboring cells. As a result of weak radio signal from the base station serving the cell, the UE cannot transmit data at higher transmit power without causing interference to other neighboring UEs.

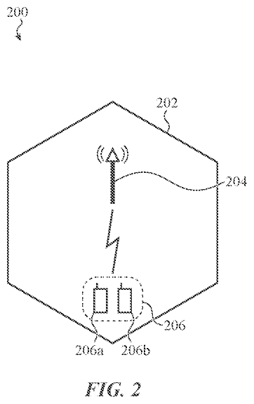

FIG. 2 depicts a virtual cluster of wireless communication devices, according to embodiments disclosed herein. As stated above, a RRC connection is used for establishing, modifying, and releasing of signaling radio bearer (SRB) and data radio bearer (DRB). Accordingly, each UE receives, from a base station to which the UE is attached, configuration information for controlling of the connection and data transmission over a RRC connection established between the UE and the base station. The connection is controlled based on control signaling information in the SRB. The data is transmitted in the DRB. Thus, each UE receives individual configuration information for managing control connection and data transmission with the base station over a RRC connection between the UE and the base station.

In a radio access network 200 of FIG. 2, a base station 204 provides radio access to UEs 206a and 206b within a coverage area of a cell 202. The UEs 206a and 206b may both be near an edge of the cell 202. The UEs at the edge of the cell require higher transmit power in comparison with the transmit power required when the UEs are near the center of the cell or more proximate to a base station serving the cell. The transmit power at which the UE may transmit data may be limited for various reasons, e.g., for avoiding interference with the other neighboring UEs. However, as described herein, the UEs 206a and 206b may be aggregated together to form a virtual cluster 206, or a super-UE 206. Through UE aggregation of the UEs 206a and 206b, a super-UE 206 may receive control signaling information for each member-UE of the virtual cluster 206 from the base station 204, at one of the member-UEs, over a RRC connection. The virtual cluster 206 here is shown to include only two UEs 206a and 206b, but there may be more than two UEs in a virtual cluster. In some cases, a number of UEs in a virtual cluster may be limited to a specific number of UEs, e.g., 10 UEs. The maximum number of UEs in the virtual cluster may be limited either by configuration at a base station and/or a core network.

In other words, in a legacy radio access network, where two RRC connections may be present for two UEs, when the two UEs are aggregated to form a virtual cluster of UEs or a super-UE, only one RRC connection is needed in some embodiments. The RRC connection for the super-UE may be between the base station and any one of the member-UEs of the super-UE. The member UE of the super-UE having a RRC connection with the base station may be referenced as an anchor-UE, while other UEs may be referenced as secondary-UEs. Accordingly, the anchor-UE may maintain an access stratum (AS) connection for all the UEs of the super-UE in the anchor-UE based super-UE connection configuration. The secondary-UEs may only be responsible for a layer1 (L1) or layer2 (L2) data transmission, and the secondary-UEs may not be responsible for any AS and/or Non-Access Stratum (NAS) signaling with the base station in the anchor-UE based super-UE configuration.

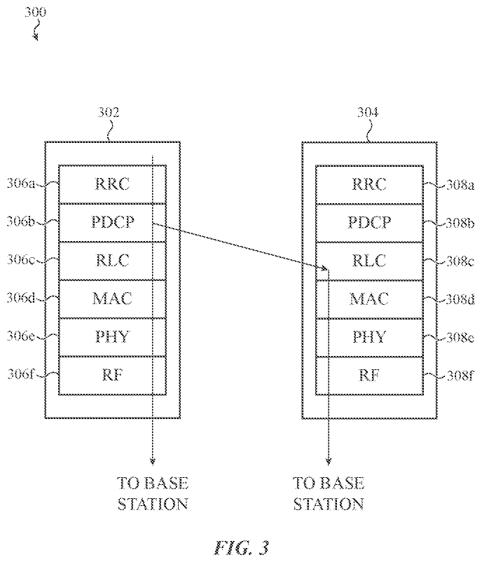

FIG. 3 depicts an example protocol stack for a super-UE, according to embodiments disclosed herein. A UE1 302 and a UE2 304 may be aggregated to form an anchor-UE based super-UE 300. Each member UE 302 and 304 of the super-UE 300 may include a protocol stack. A protocol stack 306 of the UE1 302 may include a layer1 as a PHY layer 306e, a layer2 as a MAC layer 306d, a layer3 as a RLC layer 306c, a layer4 as a PDCP layer 306b, and a layer5 as a RRC layer 306a. Similarly, a protocol stack 308 of the UE2 304 may include a layer1 as a PHY layer 308e, a layer2 as a MAC layer 308d, a layer3 as a RLC layer 308c, a layer4 as a PDCP layer 308b, and a layer5 as a RRC layer 308a.

In a legacy radio access network, each of the UE1 302 and the UE2 304 may have a RRC connection with the base station (e.g., the base station 204) over a radio frequency (RF) connection 306f and 308f, respectively, using each layer of the protocol stacks 306 and 308 described above. In accordance with some embodiments, in the anchor-UE based super-UE connection, a RRC connection may be established with the base station (e.g., the base station 204) using each layer of the protocol stack 306 or the protocol stack 308, but not both. Accordingly, the UE1 302 having a RRC connection established with the base station may be the anchor-UE of the super-UE 300 and the UE2 304 may be the secondary-UE.

In the super-UE, the secondary-UEs are responsible for L1/L2 data transmission, as stated above. Accordingly, a connection or channel may be established between the UE1 302 and the UE2 304 for transmission of data from any of the UE1 302 and/or UE2 304 to the base station. The connection or channel may be established between the UE1 302 and the UE2 304 such that the PDCP layer of the anchor-UE may have connection endpoints with an RLC layer of the anchor-UE and the secondary-UEs.

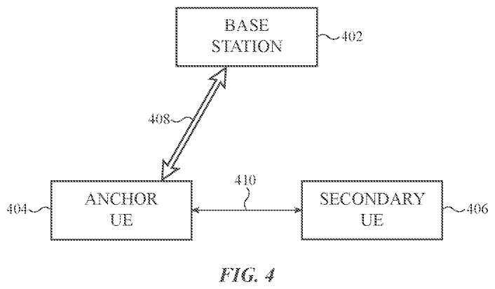

FIG. 4 depicts an example of an anchor-UE based super-UE RRC connection, according to embodiments disclosed herein. As shown in FIG. 4, an anchor-UE 404 and a secondary-UE 406 are aggregated to form a super-UE, in which the anchor-UE 404 has a RRC connection 408 with a base station 402 for the anchor-UE 404 and the secondary-UE 406. As described above, a connection or a channel 410 between the anchor-UE 404 and the secondary-UE 406 enables L1/L2 data transmission for transmission of data from any of the UE1 302 and/or UE2 304 to the base station 402. In some cases, an anchor-UE may be a UE which needs to transmit data in an uplink direction at a higher throughput without using a higher transmit power. In some cases, an anchor-UE may be a UE which helps transmit data of one or more secondary-UEs to the base station in a super-UE connection mode.

In some embodiments, aggregation of two or more UEs to form a super-UE may be achieved during an initial access procedure. During the initial access procedure, messages are exchanged between a UE and a base station for the UE to acquire uplink synchronization and a specific ID for the radio access communication. Accordingly, during the initial access procedure, a UE may indicate its capability to form a super-UE by aggregating with one or more other UEs to form a super-UE. The initial access procedure may be performed using an RRCSetupRequest or a random access channel (RACH) procedure.

In some embodiments, a UE may report super-UE specific capability in a capability report or in a super-UE suggestion information message. The capability report or the super-UE suggestion information message may indicate support for a super-UE mode, a maximum number of UEs that can join in the super-UE connection mode, L1/L2 capability of each UE link of the super-UE, and a UE identifier (UE ID) for a link for each secondary-UE.

In various embodiments, enabling of a super-UE connection mode may be determined by a UE, a base station, and/or a core network. In the present disclosure, enabling and/or disabling of the super-UE connection is described in detail.

In some embodiments, enabling and/or disabling of the super-UE connection may be based on a link quality of two or more member-UEs which may be aggregated to form the super-UE or virtual cluster. In some cases, enabling and/or disabling of the super-UE connection may be based on a link quality of an inter-UE link between two member-UEs of the super-UE. In some cases, a service level agreement for a minimum data throughput for a UE may be considered for enabling and/or disabling the super-UE connection.

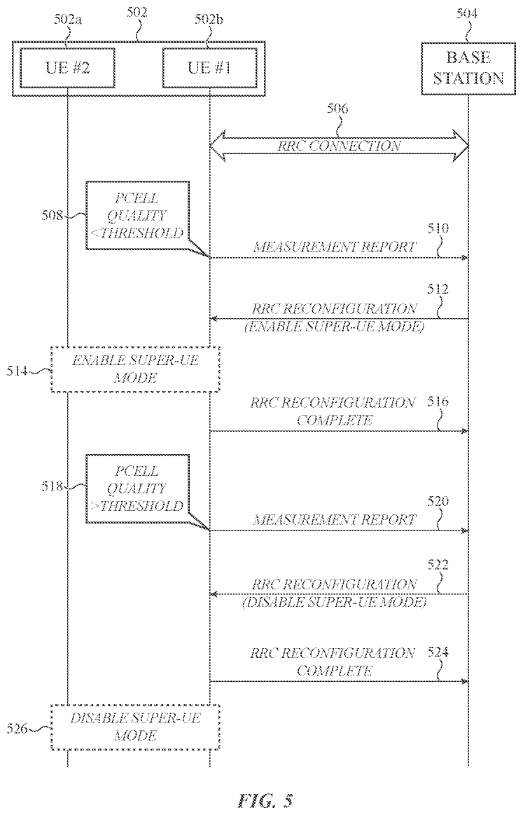

FIG. 5 depicts an example message flow for maintaining, re-establishing, and/or disabling a super-UE RRC connection based on a radio signal quality for a UE link, according to embodiments disclosed herein. A UE1 502b and a UE2 502a may be communicatively coupled with a base station 504. The UE1 502b and/or the UE2 502a may be near an edge of a serving cell of the base station 504. Each of the UE1 502b and/or the UE2 502a may have a RRC connection with the base station 504. However, only a RRC connection 506 of the UE1 502b with the base station 504 is shown in FIG. 5.

Since the UE1 502b and/or the UE2 502a are at the edge of the serving cell, radio signal strength of a UE link of the UE1 502b and/or a UE link of the UE2 502a may be degraded. The UE1 502b and/or the UE2 502a may periodically send a radio quality measurement report to the base station 504. In some cases, the base station 504 and/or a core network (not shown) may also request the UE1 502b and/or the UE2 502a to send a radio quality measurement report. The UE1 502b may send a radio quality measurement report 510 (e.g., a reference signal received power (RSRP) measurement indicating a measurement of received power from one or more reference signals, a reference signal received quality (RSRQ) measurement indicating a measurement of quality of the one or more reference signals, and/or a reference signal signal-to-noise ratio (RSSINR) measurement indicating a measurement of signal-to-noise ratio). The UE1 502b may indicate radio quality of a UE-link of the UE1 502b in the radio quality measurement report 510. The base station 504 may be configured to instruct the UE1 502b to enter into a super-UE connection mode and associate with the UE2 502a to form a super-UE 502 when the radio quality of the UE-link of the UE1 502b meets a particular threshold criterion 508. The base station may be configured by the core network to enable the super-UE connection mode when the radio quality of the UE-link of the UE1 502b meets the particular threshold criterion 508.

In some cases, radio quality of a UE-link with a base station and/or an inter-UE link may be determined based on a packet loss rate of collaborative transmission of the data payload of any member-UE to the base station, a layer1 radio link failure, a layer2 radio link control (RLC) failure, and/or an initial access procedure failure for a UE.

The base station 504 may send a RRCReconfiguration message 512 to the UE1 502b to enable the super-UE connection mode. The base station may also include configuration information for the super-UE connection mode aggregating the UE1 502b and the UE2 502a. The configuration information for the super-UE connection mode may include a super-UE ID, a link-ID of each member-UE of the super-UE, bearer capability of each UE-link of each member-UE of the super-UE and so on. The UE1 502b, upon receiving, the super-UE configuration information in the RRCReconfiguration message 512, may coordinate with the UE2 502a to form the super-UE 502 and send a RRCReconfigurationComplete message 516 to the base station 504 once super-UE mode is enabled 514.

While the UE1 502b and the UE2 502a are associated with each other in the super-UE connection mode, the UE1 502b and/or the UE2 502a may periodically and/or upon request from the base station 504 and/or the core network send a radio quality measurement report 520, which may be similar to the radio quality measurement report 510 to the base station. The UE1 502b may indicate radio quality of the UE-link of the UE1 502b in the radio quality measurement report 520. The base station 504 may be configured to instruct the UE1 502b to leave the super-UE connection mode and disassociate from the UE2 502a when the radio quality of the UE-link of the UE1 502b meets another particular threshold criterion 518. The base station may be configured by the core network to disable the super-UE connection mode when the radio quality of the UE-link of the UE1 502b meets the particular threshold criterion 518.

The base station 504 may send a RRCReconfiguration message 522 to the UE1 502b to disable the super-UE connection mode. The base station may also include configuration information for a normal-UE connection mode for the UE1 502b. The UE1 502b may coordinate with the UE2 502a to disable 526 the super-UE 502, and send RRCReconfigurationComplete message 524 to the base station 504. Upon disabling of the super-UE connection mode, UE2 502a may perform an initial access procedure to receive configuration for a UE-link of the UE2 502a in the normal mode of operation.

In some cases, enabling and/or disabling of the super-UE connection mode may also be based on an amount of data for transmission from a UE in an uplink direction. In some cases, the amount of data for transmission from the UE in the uplink direction may be determined based on historical data transmission from the UE in the uplink direction based on time and/or location. In some cases, the amount of data for transmission from the UE in the uplink direction may be determined based on a type of data, for example, audio, video, and so on.

In some cases, enabling, re-establishing, and/or maintaining a super-UE connection mode may require each UE-link for each member-UE of a super-UE to meet a specific threshold criterion for radio signal measurement. If radio quality of a UE-link for a member-UE of the super-UE worsens or drops below a specific value, then either the member-UE may be disassociated from the super-UE and/or the super-UE connection mode may be disabled for all the member-UEs. Accordingly, each member-UE of the super-UE may send a radio quality measurement report to a base station and/or a core network.

If radio quality of a UE-link for a member-UE of the super-UE worsens or drops below a specific value, then either the member-UE may be disassociated from the super-UE and/or the super-UE connection mode may be disabled for all the member-UEs. Accordingly, each member-UE of the super-UE may send a radio quality measurement report to a base station and/or a core network.

In some cases, enabling, re-establishing, and/or maintaining a super-UE connection mode may require an anchor-UE of a super-UE to report a radio signal measurement for the super-UE. In other words, the anchor-UE may be required to report a radio signal measurement for each member-UE of the super-UE. Accordingly, for example, the UE1 502b, which is an anchor-UE of the super-UE 502, may send a super-UE measurement report indicating radio quality measurement for each UE-link for each member-UE of the super-UE for each serving cell. The anchor-UE may send the radio signal measurement for the super-UE upon request from the base station and/or periodically.

In some embodiments, in a super-UE connection mode, maintaining, re-establishing, and/or disabling of the super-UE connection mode may depend on radio signal quality and/or condition of one or more inter-UE links between member-UEs of a super-UE. A member-UE of the super-UE may report radio signal quality and/or the condition of its link with an anchor-UE of the super-UE to the anchor-UE and/or a base station. The anchor-UE, upon receiving a message from a member-UE of the super-UE, may initiate a procedure to disable the super-UE connection mode or remove the member-UE from the super-UE connection mode, if an inter-UE link with the member-UE is failed and/or a radio signal quality of the inter-UE link meets certain threshold criterion. In some cases, a base station, upon receiving a message from a member-UE of the super-UE indicating an inter-UE link failure between the member-UE and the anchor-UE of the super-UE, and/or radio signal quality of the inter-UE link that meets certain threshold criterion, may initiate a procedure to disable the super-UE connection mode or remove the member-UE from the super-UE connection mode.

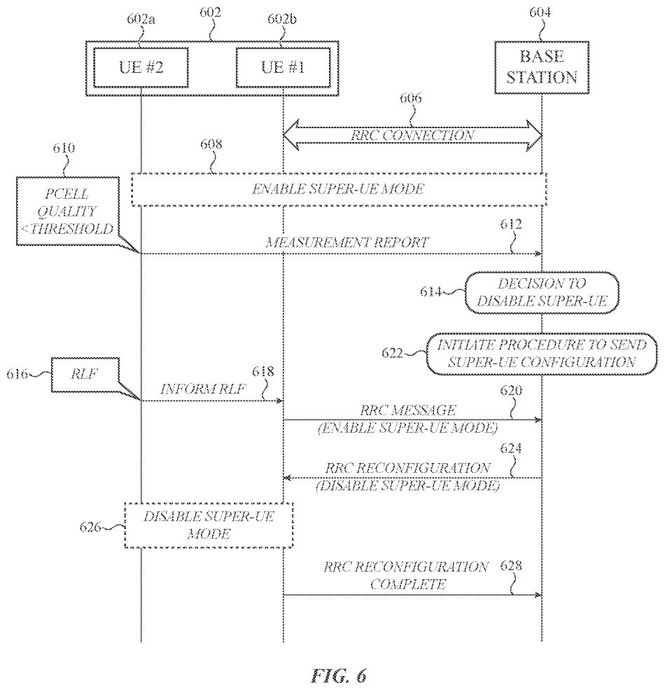

FIG. 6 depicts an example message flow for maintaining, re-establishing, and/or disabling a super-UE RRC connection based on a radio link status, according to embodiments disclosed herein. As shown in FIG. 6, a UE1 602b and a UE2 602a each may have a RRC connection with a base station 604. However, only a RRC connection 606 of the UE1 602b with the base station 604 is shown. As described above, a super-UE connection mode may be enabled 608 based on radio signal quality measurement and/or location of the UE1 602b and the UE2 602a. In some cases, the super-UE connection mode may be enabled based on a minimum data throughput at any of the UE1 602b and/or UE2 602a and/or an amount of data to be transmitted in an uplink direction from any of the UE1 602b and/or UE2 602a.

The UE2 602a may be a secondary-UE of a super-UE 602, and may send a measurement report 612 to the base station 604. The measurement report 612 from the anchor-UE 602a may indicate radio signal quality 610, which may be a radio signal quality of an inter-UE link between the UE2 602a and the UE1 602b. Based on the radio signal quality of the inter-UE link between the UE2 602a and the UE1 602b, the base station may decide to disable 614 the super-UE 602. The base station may also initiate a procedure to send configuration information 622 for a normal-mode of operation to the UE1 602b and/or the UE2 602a. The base station may send RRCReconfiguration messages to reconfigure the UE1 602b and/or the UE2 602a for the normal-mode of operation. In the normal-mode of operation, the UE sends data to the base station using a UE link between the UE and the base station.

In some cases, as shown in FIG. 6, a radio link failure 616 may be detected by a secondary-UE, such as the UE2 602a. Upon detecting the radio link failure 616, the UE2 602a may inform the anchor-UE, such as the UE1 602b, of the radio link failure 616 in a message 618. The radio link failure 616 may be failure of a radio link between the UE2 602a and the base station 604, or an inter-UE link between the UE1 602b and the UE2 602a. The radio link failure may be detected based on one or more factors including, but not limited to, packet loss, radio signal quality, latency, and so on.

The UE1 602b upon receiving the message 618 may send a RRC message 620 to the base station 604. The RRC message 620 may indicate a condition specified in the message 618. Based on the received RRC message 620 indicating failure of the inter-UE link between the UE1 602b and the UE2 602a and/or failure of the UE-link between the UE1 602b and the base station 604, the base station 604 may determine to disable the super-UE 602. The base station may send a RRCReconfiguration message 624 to disable the super-UE 602 to the UE1 602b. Upon receipt of the RRCReconfiguration message 624 at the UE1 602b, the super-UE 602 may be disabled 626, and a RRCReconfigurationComplete message 628 may be sent to the base station 604 as an acknowledgement or confirmation of disabling the super-UE connection mode.

In some embodiments, the RRC message 620 may indicate the UE1 602b's preference about the super-UE connection mode based on the received message 618. Accordingly, the RRC message 620 may include a RRC connection reestablishment request to change UE1 602b's RRC connection 606 from a super-UE RRC connection to a RRC connection for the UE1 602b only. The base station may send a RRCReconfiguration message 624 to disable the super-UE 602 to the UE1 602b. Upon receipt of the RRCReconfiguration message 624 at the UE1 602b, the super-UE 602 may be disabled 626, and a RRCReconfigurationComplete message 628 may be sent to the base station 604 as an acknowledgement or confirmation of disabling the super-UE connection mode.

In some embodiments, as described above, maintaining, re-establishing, and/or disabling of the super-UE connection mode may depend on the one or more inter-UE connections or link statuses of the two or more member-UEs of a super-UE. If the inter-UE connection or link is broken or has radio signal quality and/or latency that meets certain threshold criterion, the super-UE may be disabled. A base station and/or one or more member-UEs may be configured to detect the inter-UE connection or link status that requires disabling of the super-UE. One or more member-UEs of the super-UE, periodically and/or upon request from a base station and/or a core network, may monitor inter-UE connection or link status for reporting to the base station and/or the core network.

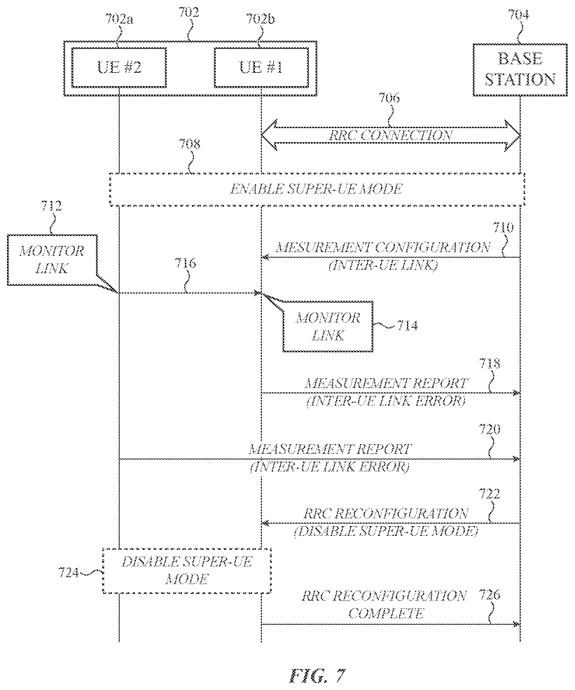

FIG. 7 depicts an example message flow for maintaining, re-establishing, and/or disabling a super-UE RRC connection based on an inter-UE connection or link status, according to embodiments disclosed herein. As shown in FIG. 7, a UE1 702b and a UE2 702a each may have a RRC connection with a base station 704. However, only a RRC connection 706 of the UE1 702b with the base station 704 is shown. As described above, a super-UE connection mode may be enabled 708 based on radio signal quality measurement and/or location of the UE1 702b and the UE2 702a. In some cases, the super-UE connection mode may be enabled based on a minimum data throughput at any of the UE1 702b and/or UE2 702a and/or an amount of data to be transmitted in an uplink direction from any of the UE1 702b and/or UE2 702a.

As stated above, the UE1 702b may receive a measurement configuration message 710 for configuring the UE1 702b for inter-UE connection of link failure detection. The measurement configuration message 710 may include one or more threshold criteria for detection of the inter-UE connection or link failure. Each UE related to an inter-UE connection or link may monitor the inter-UE connection or link 712 and 714, and may report the status of the inter-UE connection or link 716. The UE1 702b, which may an anchor-UE of a super-UE 702, may report the status of the inter-UE connection or link in a measurement report 718 to the base station 704. Additionally, or alternatively, the UE2 702a may also report the status of the inter-UE connection or link 716 to the base station 704 in a measurement report 720.

The base station 704 may initiate a procedure to disable the super-UE 702 if an inter-UE connection or link between the UE1 702b and the UE2 702a is broken. The base station 704 may send a RRCReconfiguration message 722 to disable the super-UE 702. Upon receiving the RRCReconfiguration message 722, the super-UE mode is disabled 724, and a RRCReconfigurationComplete message 726 is sent to the base station 704. In some cases, the UE1 702b and/or the UE2 702a may perform an initial access procedure for reconfiguring in a normal-mode operation.

In some embodiments, as described above, maintaining, re-establishing, and/or disabling of the super-UE connection mode may depend on the location of two or more member-UEs of a super-UE and/or a distance between the two or more member-UEs of the super-UE. One or more member-UEs of the super-UE, periodically and/or upon request from a base station and/or a core network, may monitor the location of another member-UE of the super-UE, and/or report its location to another member-UE of the super-UE, for example, an anchor-UE of the super-UE, for reporting to the base station and/or the core network.

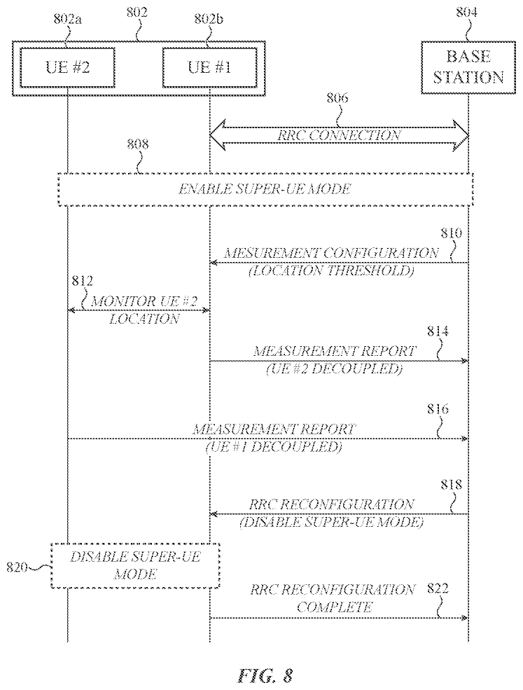

FIG. 8 depicts an example message flow for maintaining, re-establishing, and/or disabling a super-UE RRC connection based on the location of two or more UEs of a super-UE, according to embodiments disclosed herein. As shown in FIG. 8, a UE1 802b and a UE2 802a each may have a RRC connection with a base station 804. However, only a RRC connection 806 of the UE1 802b with the base station 804 is shown. As described above, a super-UE connection mode may be enabled 808 based on radio signal quality measurement and/or location of the UE1 802b and the UE2 802a. In some cases, the super-UE connection mode may be enabled based on a minimum data throughput at any of the UE1 802b and/or UE2 802a and/or an amount of data to be transmitted in an uplink direction from any of the UE1 802b and/or UE2 802a.

As stated above, the UE1 802b may receive a measurement configuration message 810 for configuring the UE1 802b for a threshold distance between the UE1 802b and the UE1 802a, for example. Each UE related to an inter-UE connection or link may monitor, determine, and/or report its location 812 to one or more member-UEs of a super-UE. Based on monitoring, determining, and/or reporting, if a distance between the UE1 802b and the UE2 802a meets or fails to meet the threshold distance criteria, a measurement report 814 may be sent to the base station 804. Additionally, or alternatively, the UE2 802a may also send a measurement report 816 identifying a status related to the distance between and/or the location of the UE1 802b and the UE2 802a to the base station 804. In one example, the status related to the distance between the UE1 802b and the UE2 802a may be UEs that are decoupled due to a large distance between them.

The base station 804 may initiate a procedure to disable the super-UE 802 as described above. The base station 804 may send a RRCReconfiguration message 818 to disable the super-UE 802. Upon receiving the RRCReconfiguration message 818, the super-UE mode is disabled 820, and a RRCReconfigurationComplete message 822 is sent to the base station 804. In some cases, the UE1 802b and/or the UE2 802a may perform an initial access procedure for reconfiguring in a normal-mode operation.

Embodiments contemplated herein include an apparatus having a means to perform one or more elements of the message flows of FIGS. 5-8. In the context of message flows of FIGS. 5-8, this apparatus may be, for example, an apparatus of a UE (such as a wireless device 1002 that is a UE, as described herein) or an apparatus of a base station (such as a network device 1020 that is a base station, as described herein).

Embodiments contemplated herein include one or more non-transitory computer-readable media storing instructions to cause an electronic device, upon execution of the instructions by one or more processors of the electronic device, to perform one or more elements of the message flows of FIGS. 5-8. In the context of message flows of FIGS. 5-8, this non-transitory computer-readable media may be, for example, a memory of a UE (such as a memory 1006 of a wireless device 1002 that is a UE, as described herein) or a memory of a base station (such as a memory 1024 of a network device 1020 that is a base station, as described herein).

Embodiments contemplated herein include an apparatus having logic, modules, or circuitry to perform one or more elements of the message flows of FIGS. 5-8. In the context of message flows of FIGS. 5-8, this apparatus may be, for example, logic, modules, or circuitry of a UE (such as a wireless device 1002 that is a UE, as described herein) or logic, modules, or circuitry of a base station (such as a network device 1020 that is a base station, as described herein).

Embodiments contemplated herein include an apparatus having one or more processors and one or more computer-readable media, using or storing instructions that, when executed by the one or more processors, cause the one or more processors to perform one or more elements of the message flows of FIGS. 5-8. In the context of message flows of FIGS. 5-8, this apparatus may be, for example, one or more processors or computer-readable media of a UE (such as a wireless device 1002 that is a UE, as described herein), or one or more processors or computer-readable media of a base station (such as a network device 1020 that is a base station, as described herein).

Embodiments contemplated herein include a signal as described in or related to one or more elements of the message flows of FIGS. 5-8.

Embodiments contemplated herein include a computer program or computer program product having instructions, wherein execution of the program by a processor causes the processor to carry out one or more elements of the message flows of FIGS. 5-8. In the context of message flows of FIGS. 5-8, the processor may be a processor of a UE (such as a processor(s) 1004 of a wireless device 1002 that is a UE, as described herein), and the instructions may be, for example, located in the processor and/or on a memory of the UE (such as a memory 1006 of a wireless device 1002 that is a UE, as described herein); or the processor may be a processor of a base station (such as a processor(s) 1022 of a network device 1020 that is a base station, as described herein), and the instructions may be, for example, located in the processor and/or on a memory of the base station (such as a memory 1024 of a network device 1020 that is a base station, as described herein).

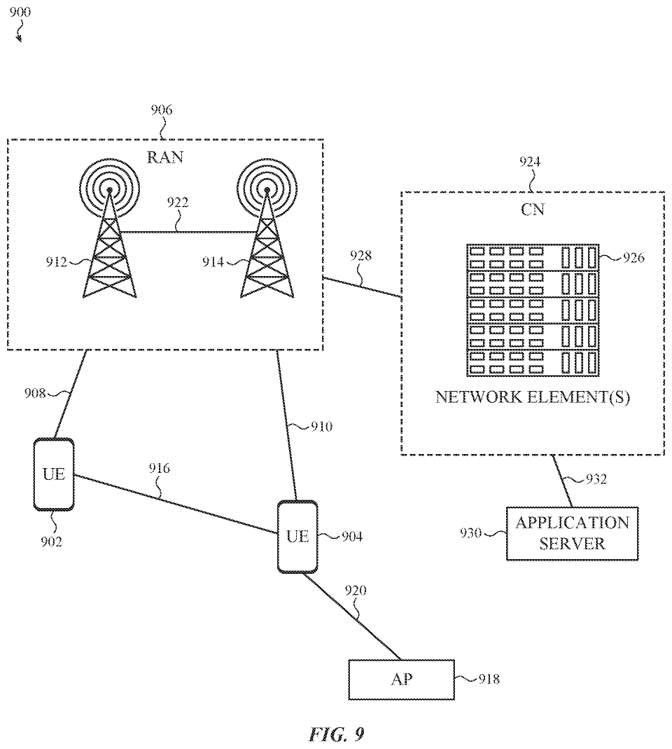

FIG. 9 illustrates an example architecture of a wireless communication system 900, according to embodiments disclosed herein. The following description is provided for an example wireless communication system 900 that operates in conjunction with the LTE system standards and/or 5G or NR system standards, and/or future standards for 6G, and so on, as provided by 3GPP technical specifications.

As shown by FIG. 9, the wireless communication system 900 includes a UE 902 and a UE 904 (although any number of UEs may be used). In this example, the UE 902 and the UE 904 are illustrated as smartphones (e.g., handheld touchscreen mobile computing devices connectable to one or more cellular networks) but may also comprise any mobile or non-mobile computing device configured for wireless communication.

The UE 902 and UE 904 may be configured to communicatively couple with a RAN 906. In embodiments, the RAN 906 may be NG-RAN, E-UTRAN, etc. The UE 902 and UE 904 utilize connections (or channels) (shown as connection 908 and connection 910, respectively) with the RAN 906, each of which comprises a physical communications interface. The RAN 906 can include one or more base stations, such as base station 912 and base station 914, that enable the connection 908 and connection 910.

In this example, the connection 908 and connection 910 are air interfaces to enable such communicative coupling and may be consistent with one or more radio access technologies (RATs) used by the RAN 906, such as, for example, an LTE and/or NR.

In some embodiments, the UE 902 and UE 904 may also directly exchange communication data via a sidelink interface 916. The UE 904 is shown to be configured to access an access point (shown as AP 918) via connection 920. By way of example, the connection 920 can comprise a local wireless connection, such as a connection consistent with any IEEE 802.11 protocol, wherein the AP 918 may comprise a Wi-Fi® router. In this example, the AP 918 may be connected to another network (for example, the Internet) without going through a CN 924.

In embodiments, the UE 902 and UE 904 can be configured to communicate using orthogonal frequency division multiplexing (OFDM) communication signals with each other or with the base station 912 and/or the base station 914 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 912 or base station 914 may be implemented as one or more software entities running on server computers as part of a virtual network. In addition, or in other embodiments, the base station 912 or base station 914 may be configured to communicate with one another via interface 922. In embodiments where the wireless communication system 900 is an LTE system (e.g., when the CN 924 is an EPC), the interface 922 may be an X2 interface. The X2 interface may be defined between two or more base stations (e.g., two or more eNBs and the like) that connect to an EPC, and/or between two eNBs connecting to the EPC. In embodiments where the wireless communication system 900 is an NR system (e.g., when CN 924 is a 5GC), the interface 922 may be an Xn interface. The Xn interface is defined between two or more base stations (e.g., two or more gNBs and the like) that connect to 5GC, between a base station 912 (e.g., a gNB) connecting to 5GC and an eNB, and/or between two eNBs connecting to 5GC (e.g., CN 924).

The RAN 906 is shown to be communicatively coupled to the CN 924. The CN 924 may comprise one or more network elements 926, which are configured to offer various data and telecommunications services to customers/subscribers (e.g., users of UE 902 and UE 904) who are connected to the CN 924 via the RAN 906. The components of the CN 924 may be implemented in one physical device or separate physical devices including components to read and execute instructions from a machine-readable or computer-readable medium (e.g., a non-transitory machine-readable storage medium).

In embodiments, the CN 924 may be an EPC, and the RAN 906 may be connected with the CN 924 via an S1 interface 928. In embodiments, the S1 interface 928 may be split into two parts, an S1 user plane (S1-U) interface, which carries traffic data between the base station 912 or base station 914 and a serving gateway (S-GW), and the S1-MME interface, which is a signaling interface between the base station 912 or base station 914 and mobility management entities (MMEs).

In embodiments, the CN 924 may be a 5GC, and the RAN 906 may be connected with the CN 924 via an NG interface 928. In embodiments, the NG interface 928 may be split into two parts, an NG user plane (NG-U) interface, which carries traffic data between the base station 912 or base station 914 and a user plane function (UPF), and the S1 control plane (NG-C) interface, which is a signaling interface between the base station 912 or base station 914 and access and mobility management functions (AMFs).

Generally, an application server 930 may be an element offering applications that use internet protocol (IP) bearer resources with the CN 924 (e.g., packet switched data services). The application server 930 can also be configured to support one or more communication services (e.g., VoIP sessions, group communication sessions, etc.) for the UE 902 and UE 904 via the CN 924. The application server 930 may communicate with the CN 924 through an IP communications interface 932.

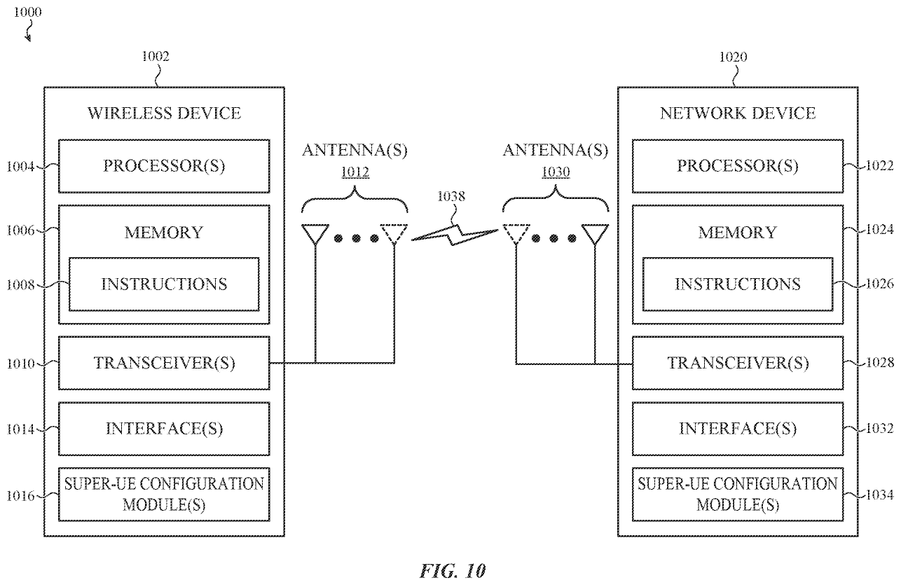

FIG. 10 illustrates a system 1000 for performing signaling 1038 between a wireless device 1002 and a network device 1020, according to embodiments disclosed herein. The system 1000 may be a portion of a wireless communications system as herein described. The wireless device 1002 may be, for example, a UE of a wireless communication system. The network device 1020 may be, for example, a base station (e.g., an eNB or a gNB) of a wireless communication system.

The wireless device 1002 may include one or more processor(s) 1004. The processor(s) 1004 may execute instructions such that various operations of the wireless device 1002 are performed, as described herein. The processor(s) 1004 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1002 may include a memory 1006. The memory 1006 may be a non-transitory computer-readable storage medium that stores instructions 1008 (which may include, for example, the instructions being executed by the processor(s) 1004). The instructions 1008 may also be referred to as program code or a computer program. The memory 1006 may also store data used by, and results computed by, the processor(s) 1004.

The wireless device 1002 may include one or more transceiver(s) 1010 that may include radio frequency (RF) transmitter and/or receiver circuitry that use the antenna(s) 1012 of the wireless device 1002 to facilitate signaling (e.g., the signaling 1038) to and/or from the wireless device 1002 with other devices (e.g., the network device 1020) according to corresponding RATs.

The wireless device 1002 may include one or more antenna(s) 1012 (e.g., one, two, four, or more). For embodiments with multiple antenna(s) 1012, the wireless device 1002 may leverage the spatial diversity of such multiple antenna(s) 1012 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1002 may be accomplished according to precoding (or digital beamforming) that is applied at the wireless device 1002 that multiplexes the data streams across the antenna(s) 1012 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1002 may implement analog beamforming techniques, whereby phases of the signals sent by the antenna(s) 1012 are relatively adjusted such that the (joint) transmission of the antenna(s) 1012 can be directed (this is sometimes referred to as beam steering).

The wireless device 1002 may include one or more interface(s) 1014. The interface(s) 1014 may be used to provide input to or output from the wireless device 1002. For example, a wireless device 1002 that is a UE may include interface(s) 1014 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1010/antenna(s) 1012 already described) that allow for communication between the UE and other devices and may operate according to known protocols (e.g., Wi-Fi®, Bluetooth®, and the like).

The wireless device 1002 may include a super-UE configuration module 1016. The super-UE configuration module 1016 may be implemented via hardware, software, or combinations thereof. For example, the super-UE configuration module 1016 may be implemented as a processor, circuit, and/or instructions 1008 stored in the memory 1006 and executed by the processor(s) 1004. In some examples, the super-UE configuration module 1016 may be integrated within the processor(s) 1004 and/or the transceiver(s) 1010. For example, the super-UE configuration 1016 may be implemented by a combination of software components (e.g., executed by a DSP or a general processor) and hardware components (e.g., logic gates and circuitry) within the processor(s) 1004 or the transceiver(s) 1010.

The super-UE configuration module 1016 may be configured to, for example, receive, determine, and/or apply super-UE connection mode related message processing and/or perform related procedures.

The network device 1020 may include one or more processor(s) 1022. The processor(s) 1022 may execute instructions such that various operations of the network device 1020 are performed, as described herein. The processor(s) 1022 may include one or more baseband processors implemented using, for example, a CPU, a DSP, an ASIC, a controller, an FPGA device, another hardware device, a firmware device, or any combination thereof configured to perform the operations described herein.

The network device 1020 may include a memory 1024. The memory 1024 may be a non-transitory computer-readable storage medium that stores instructions 1026 (which may include, for example, the instructions being executed by the processor(s) 1022). The instructions 1026 may also be referred to as program code or a computer program. The memory 1024 may also store data used by, and results computed by, the processor(s) 1022.

The network device 1020 may include one or more transceiver(s) 1028 that may include RF transmitter and/or receiver circuitry that use the antenna(s) 1030 of the network device 1020 to facilitate signaling (e.g., the signaling 1038) to and/or from the network device 1020 with other devices (e.g., the wireless device 1002) according to corresponding RATs.

The network device 1020 may include one or more antenna(s) 1030 (e.g., one, two, four, or more). In embodiments having multiple antenna(s) 1030, the network device 1020 may perform MIMO, digital beamforming, analog beamforming, beam steering, etc., as has been described.

The network device 1020 may include one or more interface(s) 1032. The interface(s) 1032 may be used to provide input to or output from the network device 1020. For example, a network device 1020 that is a base station may include interface(s) 1032 made up of transmitters, receivers, and other circuitry (e.g., other than the transceiver(s) 1028/antenna(s) 1030 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1020 may include a super-UE configuration module 1034. The super-UE configuration module 1034 may be implemented via hardware, software, or combinations thereof. For example, the super-UE configuration module 1034 may be implemented as a processor, circuit, and/or instructions 1026 stored in the memory 1024 and executed by the processor(s) 1022. In some examples, the super-UE configuration module 1034 may be integrated within the processor(s) 1022 and/or the transceiver(s) 1028. For example, the super-UE configuration module 1034 may be implemented by a combination of software components (e.g., executed by a DSP or a general processor) and hardware components (e.g., logic gates and circuitry) within the processor(s) 1022 or the transceiver(s) 1028.

The super-UE configuration module 1034 may be configured to, for example, receive, determine, and/or apply super-UE connection mode related message processing and/or perform related procedures.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

What is claimed is:

1. A user equipment (UE), comprising:
a transceiver; and
a processor configured to,
associate with a secondary UE for collaborative transmission of a data payload of one of the UE or the secondary UE to a base station;
determine a link quality with the base station or the secondary UE while associated with the secondary UE;
determine a location of the UE or the secondary UE while associated with the secondary UE;
transmit to the base station or the secondary UE, while associated with the secondary UE, at least the determined link quality or the determined location; and
determine to maintain, re-establish, or disable the association with the secondary UE based on at least one of a number of factors including: the determined link quality, the determined location, or an indication received from the base station.

2. The UE of claim 1, wherein the processor is configured to measure the link quality with the base station using one of: a reference signal received power (RSRP) measurement, a reference signal received quality (RSRQ) measurement, or a reference signal signal-to-noise ratio (RSSINR) measurement.

3. The UE of claim 1, wherein the processor is configured to measure the link quality with the secondary UE based on a latency of a link between the UE and the secondary UE.

4. The UE of claim 1, wherein the processor is configured to measure the link quality with the base station based on one or more of: a packet loss rate of the collaborative transmission of the data payload of the one of the UE or the secondary UE to the base station, a layer1 radio link failure, a layer2 radio link control (RLC) failure, or an initial access procedure failure.

5. The UE of claim 1, wherein the processor is further configured to determine a distance between the UE and the secondary UE does not meet a distance threshold received at the UE from the base station.

6. The UE of claim 1, wherein the at least one of the number of factors for determining to maintain, re-establish, or disable the association with the secondary UE further includes an amount of the data payload of the one of the UE or the secondary UE to the base station, or a throughput for transmission of the data payload of the one of the UE or the secondary UE to the base station.

7. The UE of claim 1, wherein the processor is further configured to send a link quality of the secondary UE with the base station using one of: a reference signal received power (RSRP) measurement, a reference signal received quality (RSRQ) measurement, and a reference signal signal-to-noise ratio (RSSINR) measurement.

8. The UE of claim 1, wherein the processor is further configured to:
based on a message received from the secondary UE over a link between the UE and the secondary UE, inform the base station of a radio link failure of the secondary UE with the base station for disabling the association of the UE with the secondary UE.

9. The UE of claim 1, wherein the UE is further associated with a third UE for collaborative transmission of the data payload to the base station, and
wherein the processor is further configured to:
transmit, to the base station, a radio quality measurement report including a radio quality measurement for the UE, a radio quality measurement for the secondary UE, and/or a radio quality measurement for the third UE.

10. The UE of claim 9, wherein the radio quality measurement report is transmitted in response to a request, from the base station, for the radio quality measurement report for the UE and one or more UEs with which the UE is associated for the collaborative transmission of the data payload.

11. A method of wireless communication by a user equipment (UE), comprising:
associating with a secondary UE for collaborative transmission of a data payload of one of the UE or the secondary UE to a base station;
determining a link quality with the base station or the secondary UE while associated with the secondary UE;
determining a location of the UE or the secondary UE while associated with the secondary UE;
transmitting to the base station or the secondary UE, while associated with the secondary UE, at least the determined link quality or the determined location; and
determining to maintain, re-establish, or disable the association with the secondary UE based on at least one of a number of factors including: the determined link quality, the determined location, or an indication received from the base station.

12. The method of claim 11, wherein determining the link quality with the base station or the secondary UE comprises determining the link quality with the base station or the secondary UE based on one or more factors including: latency, a packet loss rate, a layer1 radio link failure, a layer2 radio link control failure, a measurement of received power from one or more reference signals, a measurement of quality of the one or more reference signals, a measurement of signal-to-noise ratio and an initial access procedure failure.

13. The method of claim 11, wherein the at least one of the number of factors for determining to maintain, re-establish, or disable the association with the secondary UE further includes an amount of the data payload of the one of the UE or the secondary UE to the base station, or a data rate for transmission of the data payload of the one of the UE or the secondary UE to the base station.

14. The method of claim 11, further comprising:
based on a message received from the secondary UE over a link between the UE and the secondary UE, inform the base station of a radio link failure of the secondary UE with the base station for disabling the association of the UE with the secondary UE.

15. A base station, comprising:
a transceiver; and
a processor configured to:
determine a link quality or a location of at least one of a first user equipment (UE) or a secondary UE;
instruct the first UE or the secondary UE to associate with or disassociate from the secondary UE or the first UE based on at least one of the determined link quality or location of the first UE and the secondary UE; and
receive a data payload that is collaboratively transmitted by the first UE and the secondary UE while the first UE and the secondary UE are associated with each other.

16. The base station of claim 15, wherein to instruct the first UE or the secondary UE to associate with the secondary UE or the first UE, the processor is further configured to:
analyze a service level agreement of the first UE or the secondary UE for a minimum data throughput; and
determine a data throughput of the first UE or the secondary UE based on the determined link quality or location of the first UE or the secondary UE.

17. The base station of claim 15, wherein the processor is further configured to:
receive, from a core network, configuration information to instruct the first UE or the secondary UE to associate with or disassociate from the secondary UE or the first UE.

18. The base station of claim 15, wherein to instruct the first UE or the secondary UE to associate with the secondary UE or the first UE, the processor is further configured to:
determine the link quality with the first UE or the secondary UE based on one or more factors including: latency, a packet loss rate, a measurement of received power from one or more reference signals, a measurement of quality of the one or more reference signals, a measurement of signal-to-noise ratio, and an initial access procedure failure.

19. The base station of claim 15, wherein the first UE, the secondary UE, and a third UE are associated with each other for collaborative transmission of the data payload, and
wherein the processor is further configured to:
receive a message indicating failure of a link with the third UE for the first UE or the secondary UE; and
instruct the first UE and the secondary UE to disassociate from the third UE for collaborative transmission of the data payload.

20. The base station of claim 15, wherein the processor is further configured to:
receive, from a core network, configuration information for each of the first UE and the secondary UE for an association of the first UE and the secondary UE for collaborative transmission of the data payload; and
transmit, to the first UE or the secondary UE, the received configuration information for the collaborative transmission of the data payload.
